(19) United States
(12) Patent Application Publication
(10) Pub. No.: US 2016/0066059 A1
(43) Pub. Date: Mar. 3, 2016

(54) PROGRAM PLAYING DEVICE AND COMPUTER PROGRAM

(71) Applicant: SHARP KABUSHIKI KAISHA, Osaka (JP)

(72) Inventors: Takuya IWANAMI, Osaka-shi (JP); Takashi KANEKO, Osaka-shi (JP); Shuhichi WATANABE, Osaka-shi (JP); Norio ITOH, Osaka-shi (JP); Masahiro SHIOI, Osaka-shi (JP); Chanbin NI, Osaka-shi (JP); Atsutoshi SHIMENO, Osaka-shi (JP)

(73) Assignee: SHARP KABUSHIKI KAISHA, Osaka-shi, Osaka (JP)

(21) Appl. No.: 14/784,671

(22) PCT Filed: Mar. 26, 2014
(86) PCT No.: PCT/JP2014/058576

§ 371 Date: Oct. 15, 2015

(30) Foreign Application Priority Data
Apr. 19, 2013 (JP) 2013-088690

(51) Int. Cl. H04N 21/81; H04N 21/858; H04N 21/438

(52) U.S. Cl. CPC H04N 21/812; H04N 21/4383; H04N 21/8586

(57) ABSTRACT

A device (100) includes a reception unit (110) that receives a program accompanied by a main advertisement from a device (300), a processing unit (120) that displays a program image on a display unit (140), and an engine (131) that displays the main advertisement on the display unit (140). The engine (131) transmits control information indicating a method of controlling displaying a related-advertisement to a sub-device (200) that receives the related-advertisement related to the main advertisement from a server (400) and displays the received related-advertisement.

### TECHNICAL FIELD

The present invention relates to a program playing device configured to play a program content and display an advertisement, and a method of controlling displaying the advertisement on such a program playing device. The present invention also relates to a computer program that causes a computer to function as such a program playing device and a storage medium in which such a computer program is stored.

### BACKGROUND ART

Various techniques of distributing programs have been proposed (PTL 1, etc.).

When a distributor distributes a television program, it is common to distribute not only a video image of a main program but also an advertisement of a sponsor, and various techniques to enhance advertising effectiveness have been proposed.

In one of such techniques, in addition to displaying a time commercial during a commercial break in a main program, an advertisement is displayed in an area other than a display area in which a program image is displayed. For example, PTL 2 discloses a technique in which an advertisement is displayed in an advertisement display area provided in a peripheral area of a television screen. In recent digital television, depending on a program, an advertisement of a sponsor of the program is displayed in a data broadcast display area during data broadcasting.

### CITATION LIST

### Patent Literature

PTL 1: Japanese Unexamined Patent Application Publication No. 2005-333407 (laid open on Dec. 2, 2005)

PTL 2: Japanese Unexamined Patent Application Publication No. 2006-246147 (laid open on Sep. 14, 2006)

### SUMMARY OF INVENTION

### Technical Problem

However, in conventional techniques, it is not possible to flexibly display an advertisement of a sponsor in an area other than a display area of a program image.

For example, in the digital television described above, in a case where when a program of a channel A is being displayed, if the channel is switched to a channel B, then an advertisement of a sponsor of the program on the channel A, displayed in the data broadcast display area before the channel is switched, is immediately deleted. That is, when a user is interested in both the program on the channel B and the advertisement of the sponsor of the program of the channel A, if the channel is switched to the channel B, the user has to give up acquiring information provided by the advertisement.

Similarly, in the digital television described above, when an end time of a program 1 on the channel A being played is over, if a next program on the channel A, that is, a program 2 is once started to be played, a user can no longer watch an advertisement of a sponsor of the program 1 that was displayed in the data broadcast display area.

On the other hand, for example, there may be a situation in which when a user is watching a television program being played on a digital television receiver, the user may try to get information related to this program using a web browser on a tablet terminal while watching the program. In this situation, for example, in a case where a time commercial is played during a commercial break in a main program, and a URL of a website is displayed together with a message “visit the website for further information” during the time commercial, if a user wants to view this web page, the user has to input the URL on the tablet terminal. That is, in the conventional digital television, it is impossible to automatically display, on the tablet terminal, a web page of an advertisement related to a time commercial during or after a period in which the time commercial is displayed.

In view of the problem described above, a primary object of the present invention is to provide a program playing device capable of flexibly displaying an advertisement on an external display device.

### Solution to Problem

To solve the above problem, a program playing device according to an aspect of the present invention includes reception means that receives a program accompanied by an advertisement from a program distribution device, play means that plays the program so as to display a program image on a display unit, display means that displays the advertisement on the display unit, and transmission means that transmits, to an external display device configured to receive a related-advertisement related to the advertisement from an advertisement distribution device and display the received related-advertisement, control information indicating a method of controlling displaying the related-advertisement on the display device, wherein the display device is a device that controls displaying the related-advertisement according to the method of controlling displaying the related-advertisement indicated by the control information.

### Advantageous Effects of Invention

According to the aspect of the present invention, the program playing device is capable of flexibly displaying an advertisement on the display device.

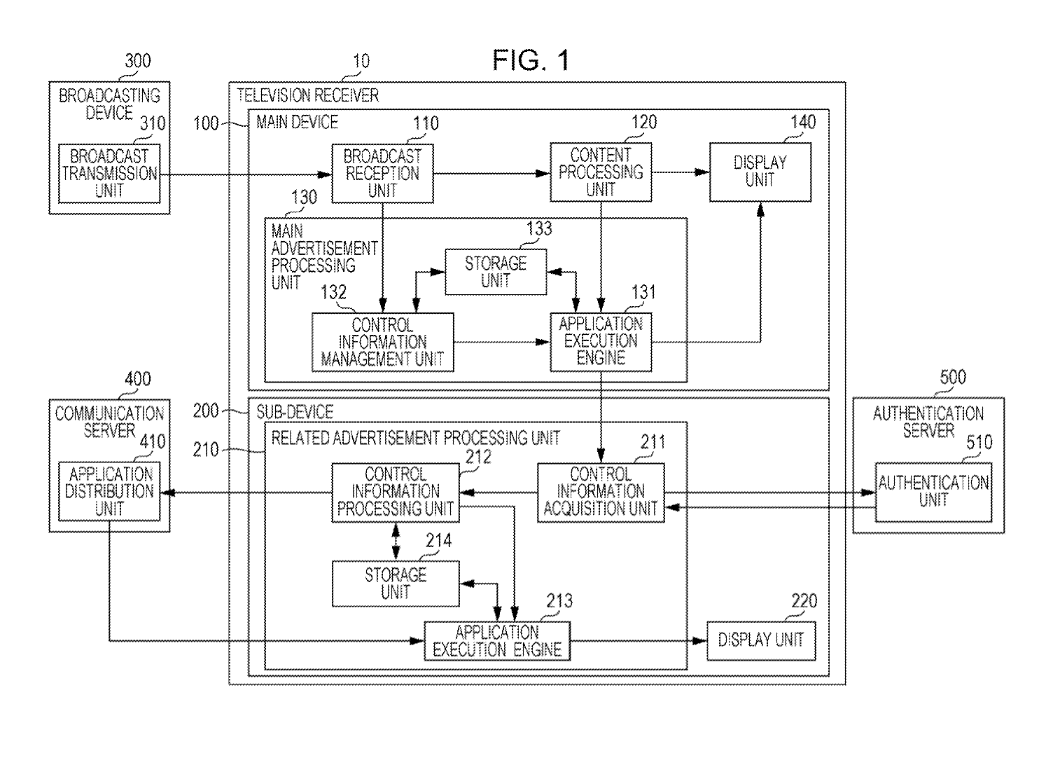

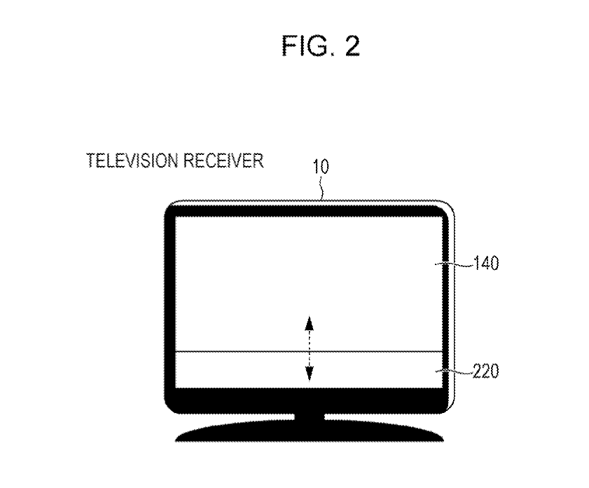

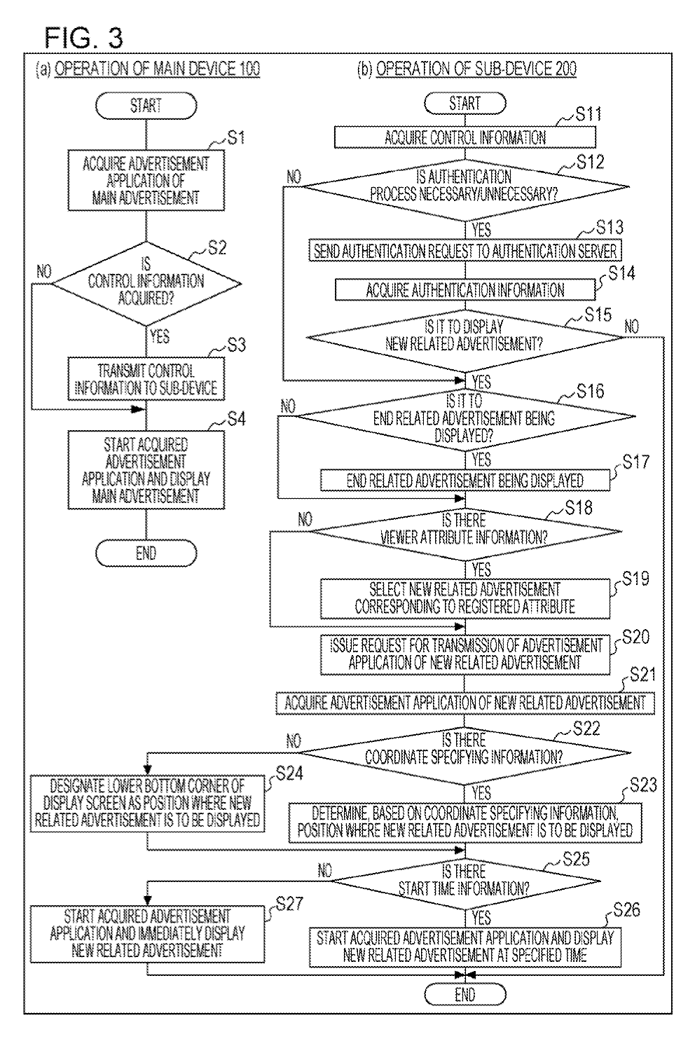

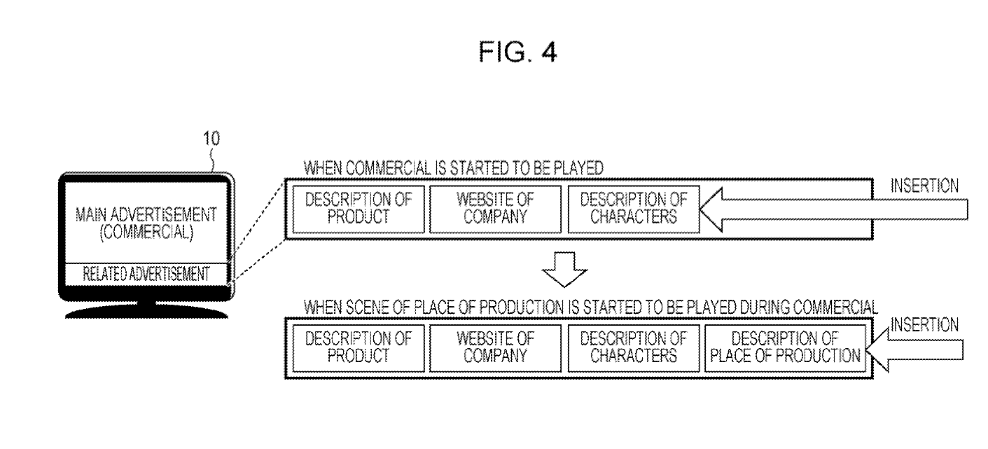

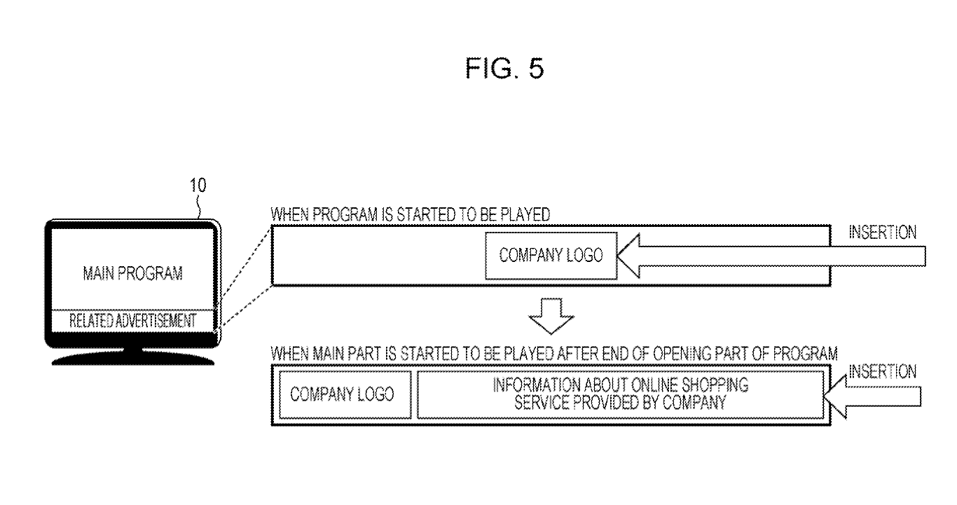

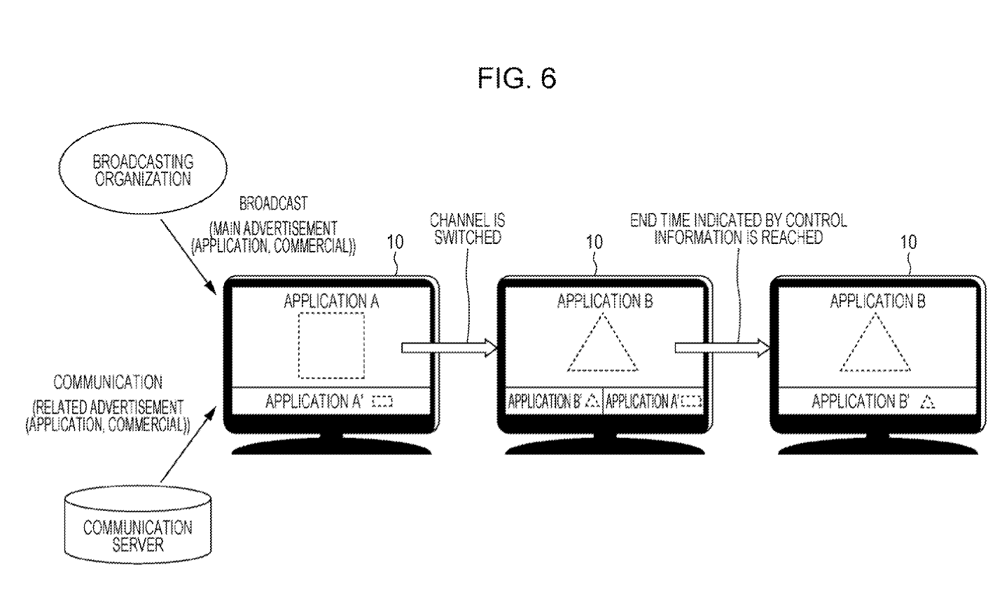

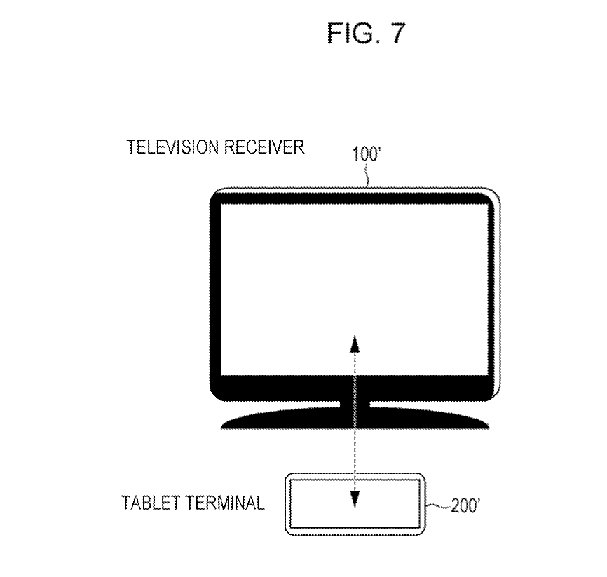

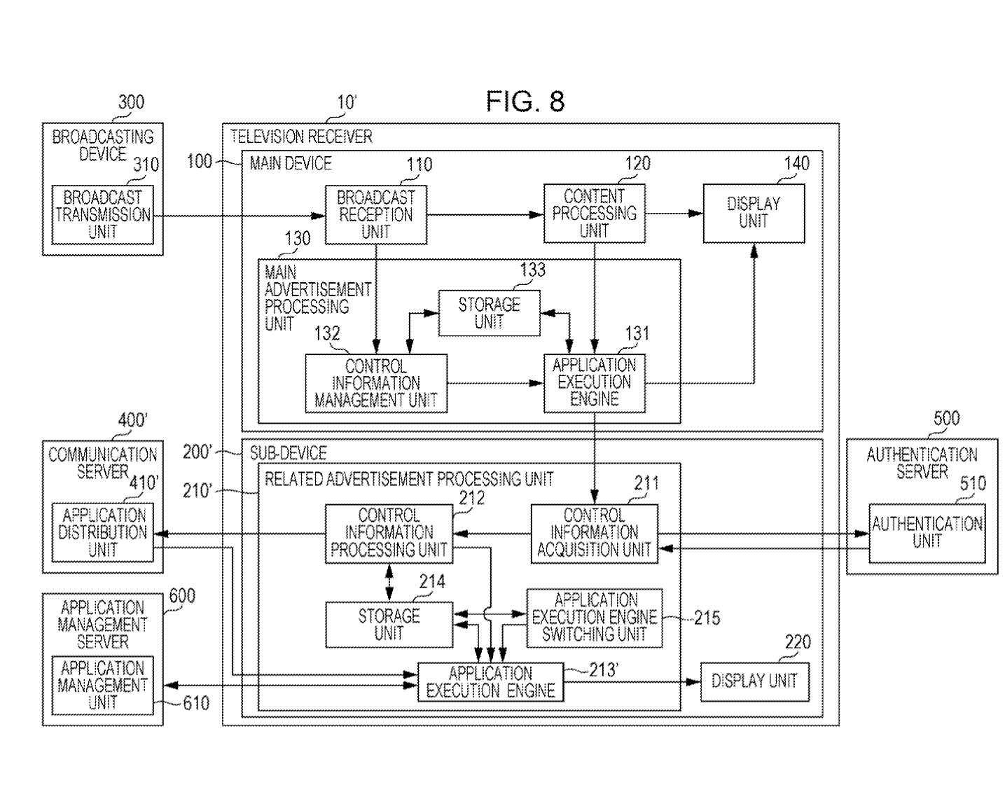

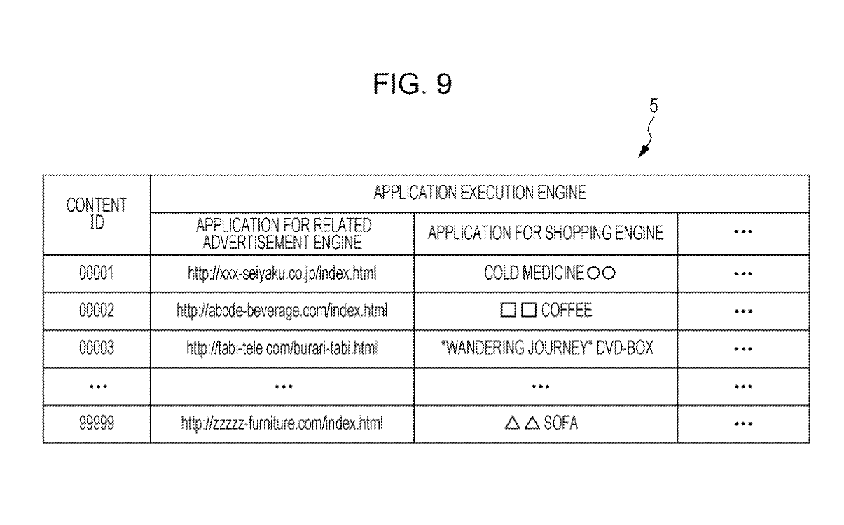

### BRIEF DESCRIPTION OF DRAWINGS

[FIG. 1] FIG. 1 is a block diagram illustrating a configuration of a television receiver according to an embodiment of the present invention.

[FIG. 2] FIG. 2 is a diagram schematically illustrating an external appearance of the television receiver shown in FIG. 1.

[FIG. 3] FIG. 3 is a flow chart illustrating an operation of the television receiver shown in FIG. 1.

[FIG. 4] FIG. 4 is a diagram schematically illustrating a manner in which a television receiver displays a related-advertisement during a commercial break according to an embodiment of the present invention.

[FIG. 5] FIG. 5 is a diagram schematically illustrating a manner in which a television receiver displays a related-advertisement during a program play period according to an embodiment of the present invention.

[FIG. 6] FIG. 6 is a diagram schematically illustrating a manner in which an advertisement is displayed on the television receiver shown in FIG. 1 before and after a channel is switched.

[FIG. 7] FIG. 7 is a diagram schematically illustrating an external appearance of a television receiver and an external appearance of a tablet terminal according to an embodiment of the present invention.

[FIG. 8] FIG. 8 is a block diagram illustrating a configuration of a television receiver in terms of main parts thereof according to another embodiment, different from the television receiver shown in FIG. 1.

[FIG. 9] FIG. 9 is a diagram illustrating an example of a related-advertisement application management table that is stored in advance by an application management server that communicates with the television receiver shown in FIG. 8.

### DESCRIPTION OF EMBODIMENTS

### First Embodiment

A television receiver according to an embodiment of the present invention is described below with reference to FIG. 1 to FIG. 6. Note that the television receiver disclosed herein is merely an example of an embodiment of the invention, and the present invention may also be applied to other types of terminals (for example, a notebook type personal computer, a tablet terminal, and the like) capable of receiving and playing an image content accompanied by an advertisement (for example, an image content on which a semitransparent advertisement image is superimposed).

FIG. 1 is a block diagram illustrating a configuration of a television receiver in terms of main parts thereof according to the present embodiment. FIG. 2 is a diagram schematically illustrating an external appearance of the television receiver according to the present embodiment.

In the television receiver 10 according to the present embodiment, as can be seen from FIG. 1 and FIG. 2, a main device 100 functioning as a broadcast reception device and a sub-device 200 functioning as a communication device are disposed in a housing of the television receiver 10. When the power of the television receiver 10 is turned on, the main device 100 and the sub-device 200 start to operate in cooperation.

More specifically, the main device 100 receives a program content in the form of a broadcast signal and plays the program content so as to display a program image. Furthermore, the main device 100 also receives an advertisement content (an advertisement application and image data of a commercial image) in the form of a broadcast signal. When the main device 100 receives an advertisement application, the main device 100 displays a main advertisement by executing the received advertisement application. An example of a main advertisement is a commercial image of a merchandise such as a home electrical appliance, a car, a food, or the like. Similarly, when the main device 100 receives image data of a commercial image, the main device 100 plays the received image data so as to display the commercial image.

On the other hand, based on control information described later supplied from the main device 100, the sub-device 200 receives an advertisement application of a related-advertisement related to the main advertisement via communication and displays the related-advertisement by executing the received advertisement application. Herein examples of related-advertisements include a detailed description of the merchandise, a link image linked to a website of a manufacturer, an image providing an introduction of a character in a commercial image, an image providing an introduction of a place of production of a merchandise in a commercial image, a company logo image, a tweet of a user about the merchandise, a link image linked to a prize site where to get the merchandise as a prize, a link image linked to a shopping site where the merchandise is available fur purchase, a link image linked to a coupon site where registered users are allowed to get the merchandise by using coupons, and the like.

The main device 100 alternately plays program images and commercial images of one or more sponsors during a program broadcast period. Note that in hereinafter, an advertisement displayed by the main device 100 by executing an advertisement application, and a commercial image are both referred to as a “main advertisement”.

Furthermore, the television receiver 10 is configured so as to allow a viewer to register an attribute (more specifically, a gender) of the viewer by using an operation unit (not illustrated). Note that although the television receiver 10 is configured so as to allow a gender to be registered as an attribute of a viewer, the present invention is not limited to such a configuration. For example, the television receiver may be configured such that an age, a resident area (for example, a prefecture of resident area), an occupation, a preference, or the like may be registered as an attribute of a viewer.

Hereinafter, a configuration of the television receiver 10 in terms of main parts thereof according to the present embodiment is described below with reference to FIG. 1.

### (Configuration of Television Receiver 10)

As illustrated in FIG. 1, the television receiver 10 includes the main device 100 and the sub-device 200.

### (Main Device 100)

The main device 100 includes a broadcast reception unit 110, a content processing unit 120, a main advertisement processing unit 130 and a display unit 140.

The broadcast reception unit 110 is a tuner that receives a broadcast signal.

When the broadcast reception unit 110 receives program image data of a program content, the content processing unit 120 plays (decodes) the program image data so as to display a program image on the display unit 140. On the other hand, when the broadcast reception unit 110 receives video data of a commercial image, the content processing unit 120 plays the image data so as to display the commercial image on the display unit 140.

When the broadcast reception unit 110 receives an advertisement application, the content processing unit 120 supplies the advertisement application to the main advertisement processing unit 130.

The main advertisement processing unit 130 includes an application execution engine 131, a control information management unit 132, and a storage unit 133.

When the application execution engine 131 receives the advertisement application from the content processing unit 120, the application execution engine 131 stores the advertisement application in the storage unit 133 and executes this advertisement application. Furthermore, the application execution engine 131 transmits the control information stored in the storage unit 133 to the sub-device 200 via a communication interface (not illustrated).

The control information management unit 132 monitors receiving of control information by the broadcast reception unit 110. When the control information management unit 132 detects that the broadcast reception unit 110 receives control information, the control information management unit 132 stores this control information in the storage unit 133.

The storage unit 133 is a storage medium for storing control information. The storage unit 133 may be a memory a hard disk drive, or other storage devices.

The display unit 140 is a display that displays a main advertisement and a program image. The display unit 140 has a screen aspect ratio of 16:9, and the screen has a horizontal length equal to the horizontal length of the screen of the display unit 220. The lower edge of the screen of the display unit 140 is in contact with the upper edge of the screen of the display unit 220.

Note that the content processing unit 120, the application execution engine 131, and the control information management unit 132 may be realized with a CPU (not illustrated).

### (Sub-Device 200)

The sub-device 200 includes a related advertisement processing unit 210 and a display unit 220.

The related advertisement processing unit 210 includes a control information acquisition unit 211, a control information processing unit 212, an application execution engine 213, and a storage unit 214.

The control information acquisition unit 211 receives control information transmitted from the main device 100 via a communication interface (not illustrated), and the control information acquisition unit 211 transmits the received control information to an authentication server 500 to verify the authenticity of the received control information.

If the control information acquisition unit 211 confirms, based on a response from the server 500, that the received control information is valid, the control information acquisition unit 211 transmits the control information to the control information processing unit 212.

Note that in the present embodiment, the control information acquisition unit 211 verifies the authenticity of the received control information only when the necessity of an “authentication verification process” is set as “true” in the television receiver 10. That is, in a case where the necessity of the “authentication verification process” is set as “false” by a user, the control information acquisition unit 211 directly supplies the received control information to the control information acquisition unit 211 without confirming the authenticity of the received control information.

The control information processing unit 212 stores the control information supplied from the control information acquisition unit 211 in the storage unit 214, and, based on this control information, the control information processing unit 212 transmits, to the communication server 400, a transmission request for an advertisement application of a related-advertisement, and notifies the application execution engine 213 that the transmission request has transmitted to the communication server 400.

In response to receiving the notification, the application execution engine 213 waits for the advertisement application to be received from the communication server 400. When the application execution engine 213 receives the advertisement application from the communication server 400, the application execution engine 213 stores the received advertisement application in the storage unit 214. Furthermore, based on the control information stored in the storage unit 214, the application execution engine 213 starts the advertisement application stored in the storage unit 214 and displays the related-advertisement on the display unit 220.

When the advertisement application ends, the application execution engine 213 deletes, from the storage unit 214, this advertisement application and the control information referred to by the control information processing unit 212 to acquire the advertisement application from the communication server 400. Alternatively, when the advertisement application ends, the application execution engine 213 may maintain, in the storage unit 214, this advertisement application and the control information referred to by the control information processing unit 212 to acquire the advertisement application from the communication server 400. In this case, re-transmission is not necessary for the same advertisement applications as those transmitted before, and thus it becomes possible to reduce the amount of transmission data size for the advertisement application.

The display unit 220 is a display on which related-advertisements are displayed. The display unit 220 has a screen aspect ratio of 16:1, and the screen has a horizontal length equal to the horizontal length of the screen of the display unit 140. The upper edge of the screen of the display unit 220 is in contact with the lower edge of the screen of the display unit 140.

The configuration of the television receiver 10 according to the present embodiment has been described above. Hereinafter, other devices according to the present embodiment are described.

### (Broadcasting Device 300)

The broadcasting device 300 is a distribution device capable of distributing program contents, and the broadcasting device 300 includes a broadcast transmission unit 310.

The broadcast transmission unit 310 of the broadcasting device 300 alternately transmits program images and commercial images of one or more sponsors during a program broadcast period.

Furthermore, the broadcast transmission unit 310 transmits an advertisement application of a main advertisement periodically at constant intervals according to a data carousel transmission method.

Furthermore, the broadcast transmission unit 310 transmits control information at a predetermined time. In the present embodiment, when the advertisement application of the main advertisement is transmitted, the broadcast transmission unit 310 transmits control information indicating a method of controlling displaying a related-advertisement related to the main advertisement. Note that the control information may be transmitted as data attached to the advertisement application.

Note that the broadcasting device 300 does not necessarily need to be configured to transmit control information whenever an advertisement application of a main advertisement is transmitted. That is, the broadcasting device 300 may transmit control information only when an advertisement application for a main advertisement of a sponsor who pays high an advertising fee is transmitted. In other words, for an advertisement application for a sponsor who wants to present only a main advertisement to program viewers to reduce advertising expenses, no attached data is prepared such that no control information is transmitted when the advertisement application is transmitted.

### (Communication Server 400)

In the communication server 400, a large number of advertisement applications of related-advertisements are stored.

An application distribution unit 410 of the communication server 400 distributes, to the television receiver 10, an advertisement application requested to be transmitted by the television receiver 10.

### (Authentication Server 500)

The authentication server 500 is a server that verifies authenticity of control information.

When the authentication unit 510 of the authentication server 500 receives control information from the television receiver 10, the authentication unit 510 determines, using a known method, whether the control information is valid or not, and the authentication unit 510 returns information indicating a result of the determination as to the validity to the television receiver 10.

### (Details of Control Information)

Next, details of control information are described below.

The control information is information indicating a method to be obeyed by the sub-device 200 in controlling displaying a related-advertisement. The control information generally includes information (1) to (6) described below. Note that in the present embodiment, the control information has to include URL information.

(1) URL information: Information indicating URL of a site where an advertisement application of a related-advertisement is available.
(2) Start time information: Information indicating a time at which the advertisement application of the related-advertisement is to be started.
(3) Acquisition time information: Information indicating a time at which the advertisement application of the related-advertisement is to be acquired from the communication server 400.
(4) End time information: Information indicating a time at which the advertisement application of the related-advertisement is to be ended.
(5) Coordinate specifying information: Information indicating with what size and in which area of the display screen of the display unit 220 the related-advertisement is to be displayed.
(6) Management information on old advertisement application: Information indicating whether an old advertisement application is to be ended or not when another advertisement application is started.

Regarding coordinate specifying information of (5), for example, the coordinate specifying information may be information including upper left coordinates and lower right coordinates of a rectangular area in which a related-advertisement is to be displayed, or the coordinate specifying information may be information including upper left coordinates of a rectangular area in which the related-advertisement is to be displayed and a vertical length and a horizontal length of this rectangular area. The coordinate specifying information may include a description of a size and a shape of an area in which the related-advertisement is to be displayed.

On the other hand, regarding the URL information of (1), there is a possibility that the control information includes a plurality of pieces of URL information depending on the attribute of a viewer. More specifically, there is a possibility that the control information includes two pieces of URL information corresponding to gender of a viewer (URL information of an advertisement application for a male viewer and URL information of an advertisement application for a female viewer).

Note that in the control information, for example, URL of an advertisement application for men may be described in the form of “http://cdn1.example.com/get_adv1_male.exe”, while URL of an advertisement application for women may be described in the form of “http://cdn1.example.com/get_adv1_female.exe”. On the other hand, in a case where in the control information, URL is described to the right of a character string of “[MALE]”, the television receiver 10 may regard this URL as a URL of an advertisement application for men. Similarly, in a case where in the control information, URL is described to the right of a character string of “[FEMALE]”, the television receiver 10 may regard this URL as a URL of an advertisement application for women. Hereinafter, such a character string indicating an attribute of a viewer associated with URL information (in the example described above, a character string of “[MALE]” and a character string of “[FEMALE]”) will be referred to as “viewer attribute information”.

The control information may include three pieces of URL information corresponding not to the gender but to ages of viewers (URL information of an advertisement for children, URL information of an advertisement for adults, and URL information of an advertisement for seniors). Alternatively, the control information may include a plurality of pieces of URL information corresponding not to the gender of a viewer but to a resident area, an occupation, or a preference of the viewer.

The control information may be data in the form of a table.

### (Operation of Television Receiver 10)

Next, an operation of the television receiver 10 is described below with reference to FIG. 3 for a case where the broadcasting device 300 corresponding to a current channel of the television receiver 10 transmits an advertisement application.

FIG. 3 is a flow chart illustrating the above-described operation of the television receiver 10. More specifically, a flow chart of (a) in FIG. 3 represents an operation of the main device 100, and a flow chart of (b) in FIG. 3 represents an operation of the sub-device 200.

If the broadcasting device 300 transmits an advertisement application, then, as illustrated in (a) of FIG. 3, the main device 100 acquires the advertisement application (step S1). That is, the broadcast reception unit 110 receives an advertisement application and supplies the received advertisement application to the content processing unit 120, the content processing unit 120 supplies the advertisement application to the application execution engine 131, and the application execution engine 131 stores the advertisement application in the storage unit 133.

After step S1, the control information management unit 132 determines whether the broadcast reception unit 110 has acquired control information together with the advertisement application (step S2). In a case where it is determined that control information is not acquired by the broadcast reception unit 110, the television receiver 10 proceeds to step S4.

In the case where it is determined that control information is acquired together with the advertisement application by the broadcast reception unit 110, the control information management unit 132 receives the control information from the broadcast reception unit 110 and stores the received control information, in relation to the advertisement application acquired in step Si, in the storage unit 133. The application execution engine 131 transmits the control information stored in the storage unit 133 to the sub-device 200 (step S3). After step S3, the television receiver 10 proceeds to step S4.

In step S4, the application execution engine 131 starts the advertisement application acquired in step Si and displays the main advertisement on the display unit 140. Note that in step S4, the application execution engine 131 may display the main advertisement so as to have no overlap with a program image of a current channel or so as to be superimposed on the program image of the current channel.

On the other hand, in a case where the control information is transmitted in step S3 by the application execution engine 131 to the sub-device 200, then as illustrated in (b) of FIG. 3, the control information acquisition unit 211 of the sub-device 200 acquires the control information (step S11).

The control information acquisition unit 211 determines whether the necessity of the “authentication verification process” is set to “true” or “false” (step S12). In a case where it is determined that the necessity of the “authentication verification process” is set as “false”, the control information acquisition unit 211 proceeds to step S16. On the other hand, in a case where it is determined that the necessity of the “authentication verification process” is set as “true”, the control information acquisition unit 211 proceeds to step S13.

In step S13, the control information acquisition unit 211 transmits, to the authentication server 500, the control information acquired in step S11 for requesting the authentication server 500 to authenticate the control information.

When the control information is received by the authentication server 500, then authentication unit 510 judges the authenticity of the control information by using a known method. Thereafter, the authentication server 500 transmits authentication information indicating a result of the judgment as to the authenticity to the sub-device 200. The control information acquisition unit 211 of the sub-device 200 acquires the authentication information (step S14).

After step S14, to determine whether the sub-device 200 is to display a new related-advertisement, the control information acquisition unit 211 confirm whether the authenticity of the control information is valid or not based on the authentication information acquired in step S14 (step S15). In a case where it is not confirmed in step S15 that the authenticity of control information is valid, the sub-device 200 ends the process without displaying the related-advertisement. On the other hand, in a case where it is confirmed in step S15 that the authenticity of control information is valid, the control information acquisition unit 211 supplies the control information to the control information processing unit 212. Thereafter, the sub-device 200 proceeds to step S16.

In step S16, the control information processing unit 212 stores the control information received from the control information acquisition unit 211 in the storage unit 214, and the control information processing unit 212 determines whether the related-advertisement being displayed is to be deleted (that is, whether the advertisement application of the related-advertisement being displayed is to be ended). More specifically, based on management information on an old advertisement application, it is determined whether or not to end the old advertisement application being in operation. In a case where it is determined that the old advertisement application being in operation is not to be ended, the control information processing unit 212 proceeds to step S18.

On the other hand, in a case where it is determined that the old advertisement application being in operation is to be deleted, the control information processing unit 212 ends the old advertisement application being in operation thereby deleting the related-advertisement being displayed (step S17). After step S17, the control information processing unit 212 proceeds to step S18.

In step S18, the control information processing unit 212 determines whether the control information includes viewer attribute information. In a case where it is determined that the control information includes no viewer attribute information, the control information processing unit 212 proceeds to step S20. In a case where it is determined that the control information includes viewer attribute information, the control information processing unit 212 proceeds to step S19.

In step S19, the control information processing unit 212 determines that an advertisement application of a related-advertisement corresponding to the attribute registered in the television receiver 10 is to be acquired. More specifically, in a case where the gender of the viewer registered in the television receiver 10 indicates the male, the control information processing unit 212 determines that an advertisement application of a related-advertisement for men is to be acquired. On the other hand, in a case where the gender of the viewer registered in the television receiver 10 indicates the female, the control information processing unit 212 determines that an advertisement application of a related-advertisement for women is to be acquired. After step S19, if the time indicated by the acquisition time information is reached, the control information processing unit 212 proceeds to step S20.

In step S20, based on the URL information in the control information, the control information processing unit 212 requests the communication server 400 to transmit the advertisement application of the related-advertisement. More specifically, in a case where the immediately old step was step S19, the control information processing unit 212 retrieves URL information corresponding to the registered gender from a plurality of pieces of URL information in the control information and, based on this URL information, requests the communication server 400 to transmit an advertisement application. On the other hand, in a case where the immediately old step was not step S19, then based on the URL information, which is only one piece of URL information existing in the control information, the control information processing unit 212 requests the communication server 400 to transmit an advertisement application.

In response to receiving the request, the application distribution unit 410 of the communication server 400, transmits the requested advertisement application to the sub-device 200.

The application execution engine 213 of the sub-device 200 acquires the advertisement application transmitted in step S21 by the communication server 400, and stores the acquired advertisement application in the storage unit 214. More specifically, the acquired advertisement application is stored in the storage unit 214 such that the advertisement application is related to the control information stored in step S16 in the storage unit 214.

After step S21, the application execution engine 213 determines whether the control information includes coordinate specifying information (step S22). In a case where it is determined that the control information includes coordinate specifying information, the application execution engine 213 determines that a new related-advertisement is to be displayed in an area specified by the coordinate specifying information (step S23). On the other hand, in a case where it is determined that the control information does not include coordinate specifying information, the application execution engine 213 determines that a new related-advertisement is to be displayed in an area in a lower right corner of the display unit 220 (step S24). After step S23 or step S24, the application execution engine 213 proceeds to step S25.

In step S25, the application execution engine 213 determines whether the control information includes start time information (step S25). In a case where it is determined that the control information includes start time information, the application execution engine 213 proceeds to step S26. In a case where it is determined that the control information does not include start time information, the application execution engine 213 proceeds to step S27.

In step S26, when the time indicated by the start time information is reached, the application execution engine 213 starts the advertisement application acquired in step S21 and displays the new related-advertisement according to the determination made in step S23 or step S24.

On the other hand, in step S27, the application execution engine 213 starts the advertisement application acquired in step S21 immediately after the determination made in step S25, and displays the new related-advertisement according to the determination made in step S23 or step S24.

After that, the application execution engine 213 continues displaying the related-advertisement until the time (end time) indicated by the end time information included in the control information is reached, and the process is ended.

Note that in a case where a new advertisement application is received together with control information before the time indicated by the end time information is reached, the sub-device 200 performs a process described below.

In a case where the management information associated with the old advertisement application included in the received control information indicates that the old advertisement application is to be ended when the advertisement application is started, the application execution engine 213 immediately ends the advertisement application started in step S26 or step S27. That is, the application execution engine 213 immediately deletes the related-advertisement displayed by executing the advertisement application.

On the other hand, in a case where the management information associated with the old advertisement application included in the received control information does not indicate that the old advertisement application is to be ended when the advertisement application is started, the application execution engine 213 continues executing the advertisement application started in step S26 or step S27 until the end time is reached. That is, the application execution engine 213 continues displaying the related-advertisement by the old advertisement application until the end time is reached, and the application execution engine 213 deletes the related-advertisement at a point of time when the end time is reached.

The operation of the television receiver 10 has been described above.

### (Advantages of Television Receiver 10)

As described above, the main device 100 of the television receiver 10 includes the broadcast reception unit 110 that receives a program accompanied by a main advertisement from the broadcasting device 300, the content processing unit 120 that plays the program so as to display a program image on the display unit 140, and the application execution engine 131 that displays a main advertisement on the display unit 140.

In response to receiving an advertisement application of a main advertisement when a program is being played, then, to the sub-device 200 that receives a related-advertisement related to the main advertisement from the communication server 400 and displays the received related-advertisement, the application execution engine 131 transmits control information indicating a method of controlling displaying the related-advertisement by the sub-device 200.

On the other hand, the sub-device 200 located outside the main device 100 controls displaying of the related-advertisement according to the display control method indicated in the control information.

Thus the main device 100 provides an advantage that it becomes possible to flexibly display an advertisement in the sub-device 200.

### Second Embodiment

Another embodiment of the present invention is described below with reference to FIG. 1 and FIG. 4. FIG. 4 is a diagram schematically illustrating a manner in which a television receiver displays a related-advertisement during a commercial break according to the present embodiment of the invention. The television receiver according to the present embodiment has a similar configuration to that of the television receiver 10 according to the first embodiment illustrated in FIG. 1, and thus a description of parts thereof is omitted.

In the present embodiment, unlike the first embodiment, the broadcasting device 300 transmits control information indicating a method of controlling displaying a related-advertisement related to a main advertisement (a commercial image in the present embodiment) not only at a time at which an advertisement application of the main advertisement is transmitted but also during an operation of distributing the commercial image. More specifically, the broadcasting device 300 transmits control information associated with commercials of some sponsors (hereafter also referred to as “commercial of interest”) when the commercial of interest is started, and the broadcasting device 300 further transmits control information when a scene representing a place of production of a merchandise, which is one of a plurality of scenes included in the commercial of interest, is started.

Hereinafter, in the description of the television receiver 10, a start time of a commercial of interest is denoted by T₁, a start time of a scene about a place of production of the merchandise in the commercial of interest is denoted by T₂, and an end time of the commercial of interest is denoted by T₃.

When time T₁ is reached, the broadcasting device 300 transmits control information (hereinafter referred to as “control information A”) including URL information indicating a URL of an advertisement application that displays an image describing a merchandise of a sponsor, a link image linked to a website of the sponsor, and a link image linked to a site where a character in the commercial is introduced. The control information A includes T₁ as start time information and acquisition time information and T₃ as end time information.

When the broadcast reception unit 110 of the television receiver 10 receives the control information A, the control information management unit 132 supplies the control information A to the application execution engine 131, and the application execution engine 131 transmits the control information A to the sub-device 200.

In the sub-device 200, upon receiving the control information A, the control information processing unit 212 receives the control information A from the control information acquisition unit 211 and stores the control information A in the storage unit 214. Based on the acquisition time information included in the control information A, the control information processing unit 212 immediately transmits an advertisement application transmission request to the communication server 400. The application execution engine 213, in response to receiving the advertisement application, stores the advertisement application in the storage unit 214, and immediately starts the advertisement application based on the start time information included in the control information A.

Thus, as illustrated in FIG. 4, after time T₁ is reached, a description image of the merchandise of the sponsor, a link image linked to a website of the sponsor, and a link image linked to a website where a character in the commercial is introduced are displayed as related advertisements on the display unit 220.

Thereafter, when time T₂ is reached, the broadcasting device 300 transmits control information (hereinafter, referred to as “control information B) including URL information indicating a URL of an advertisement application for displaying an image about a place of production of the merchandise of the sponsor. The control information B includes T₂ as start time information and acquisition time information and T₃ as end time information. Note that management information on an old advertisement application included in the control information B specifies that the old advertisement application is not to be ended when an advertisement application is started.

When the broadcast reception unit 110 of the television receiver 10 receives the control information B, the control information management unit 132 supplies the control information B to the application execution engine 131, and the application execution engine 131 transmits the control information B to the sub-device 200.

In the sub-device 200, upon receiving the control information B, the control information processing unit 212 receives the control information B from the control information acquisition unit 211 and stores the control information B in the storage unit 214. Based on the acquisition time information included in the control information B, the control information processing unit 212 immediately transmits an advertisement application transmission request to the communication server 400. The application execution engine 213, in response to receiving the advertisement application, stores the advertisement application in the storage unit 214 and immediately starts the advertisement application based on the start time information included in the control information B. According to the management information included in the control information B in terms of the old advertisement application, the application execution engine 213 continues the operation of the old advertisement application started according to the control information A.

Thus, as illustrated in FIG. 4, after time T₂ is reached, an image representing the place of the production of the merchandise of the sponsor is newly displayed as a related advertisement on the display unit 220.

Thereafter, when time T₃ is reached, the application execution engine 213 ends the two advertisement applications being in operation according to the end time information described in the control information A and the end time information described in the control information B thereby deleting the related-advertisements related to the commercial of interest. Furthermore, the application execution engine 213 deletes the two advertisement applications, the control information A, and the control information B from the storage unit 214.

### Third Embodiment

Another embodiment of the present invention is described below with reference to FIG. 1 and FIG. 5. FIG. 5 is a diagram schematically illustrating a manner in which a television receiver displays a related-advertisement during a period of playing a program (for example, a movie program) according to the embodiment. The television receiver according to the present embodiment has a similar configuration to that of the television receiver 10 according to the first embodiment illustrated in FIG. 1, and thus a description of parts thereof is omitted.

In the present embodiment, unlike the first embodiment, the broadcasting device 300 transmits control information indicating a method of controlling displaying a related-advertisement related to a main advertisement, not only at a time at which an advertisement application of the main advertisement is transmitted but also at a program start time and at a main part start time after an opening part is ended.

Hereinafter, in the description of the television receiver 10 according to the present embodiment, a program start time is denoted by T₄, a main program start time is started is denoted by T₅, and a program end time is denoted by T₆.

When time T₄ is achieved, the broadcasting device 300 transmits control information (hereinafter referred to as “control information C”) including URL information indicating a URL of an advertisement application to display an image of a company logo. The control information C includes T₄ as start time information and acquisition time information and T₆ as end time information.

When the broadcast reception unit 110 of the television receiver 10 receives the control information C, the control information reception unit 132 supplies the control information C to the application execution engine 131, and the application execution engine 131 transmits the control information C to the sub-device 200.

In the sub-device 200, upon receiving the control information C, the control information processing unit 212 receives the control information C from the control information acquisition unit 211 and stores the control information C in the storage unit 214. Based on the acquisition time information included in the control information C, the control information processing unit 212 immediately transmits an advertisement application transmission request to the communication server 400. The application execution engine 213, in response to receiving the advertisement application, stores the advertisement application in the storage unit 214 and immediately starts the advertisement application based on the start time information included in the control information C.

Thus, as illustrated in FIG. 5, after time T₄ is reached, a logo of a sponsor company is displayed on the display unit 220.

Thereafter, when time T₅ is reached, the broadcasting device 300 transmits control information (hereinafter referred to as “control information D”) including URL information indicating a URL of an advertisement application to display a link image linked to a shopping site operated by the sponsor company. The control information D includes T₅ as start time information and acquisition time information and T₆ as end time information. Note that management information on an old advertisement application included in the control information D specifies that the old advertisement application is not to be ended when an advertisement application is started.

When the broadcast reception unit 110 of the television receiver 10 receives the control information D, the control information management unit 132 supplies the control information D to the application execution engine 131, and the application execution engine 131 transmits the control information D to the sub-device 200.

In the sub-device 200, upon receiving the control information D, the control information processing unit 212 receives the control information D from the control information acquisition unit 211 and stores the control information D in the storage unit 214. Based on the acquisition time information included in the control information D, the control information processing unit 212 immediately transmits an advertisement application transmission request to the communication server 400. The application execution engine 213, in response to receiving the advertisement application, stores the advertisement application in the storage unit 214 and immediately starts the advertisement application based on the start time information included in the control information D. Furthermore, based on the management information included in the control information D as to handling of the old advertisement application, the application execution engine 213 continues the operation of the old advertisement application started based on the control information A.

Thus, as illustrated in FIG. 5, after time T₅ is reached, a link image linked to a shopping site operated by the sponsor company is newly displayed as a related-advertisement on the display unit 220.

Thereafter, when time T₆ is reached, based on the end time information in the control information C and the control information D, the application execution engine 213 ends the two advertisement applications being in operation thereby deleting the related-advertisements being displayed, and deletes the two advertisement application, the control information A, and the control information B from the storage unit 214.

### Fourth Embodiment

Still another embodiment of the present invention is described below with reference to FIG. 8 and FIG. 9. FIG. 8 is a block diagram illustrating a configuration of a television receiver in terms of main parts thereof according to the present embodiment. FIG. 9 is a diagram illustrating an example of a related-advertisement application management table that is stored in advance by an application management server that communicates with the television receiver according to the present embodiment.

In the present embodiment, the television receiver is configured so as to be capable of accepting a selection by a viewer as to a type of an advertisement application to be executed by the sub-device. By executing the advertisement application of the type selected by the viewer, it is possible to display a related-advertisement in a manner according to a preference of the viewer.

First, a configuration of the television receiver 10′ according to the present embodiment is described below with reference to FIG. 8.

### (Television Receiver 10′)

As illustrated in FIG. 8, the television receiver 10′ includes a main device 100 and a sub-device 200′. As can be seen from FIG. 1, the main device 100 has a similar configuration to that of the main device 100 of the television receiver 10, and thus a description of parts thereof is omitted.

### (Sub-Device 200′)

The sub-device 200′ includes a related advertisement processing unit 210′ and a display unit 220.

The related advertisement processing unit 210′ includes a control information acquisition unit 211, a control information processing unit 212, an application execution engine 213′, a storage unit 214, and an application execution engine switching unit 215.

The control information acquisition unit 211, the control information processing unit 212, the storage unit 214, and the display unit 220 are similar to those described above in the first embodiment, and thus a further description thereof is omitted here, and a description given below focuses on the application execution engine 213′ and the application execution engine switching unit 215.

The application execution engine 213′ includes a plurality of sub-engines (applications). Each sub-engine is configured to acquire an advertisement application of a type different from that acquired by the other sub-engines and execute the acquired advertisement application. When a viewer selects a type of an advertisement application via an operation unit (not illustrated), then, among the plurality of sub-engines, only one sub-engine corresponding to the selected type operates.

Note that in the present embodiment, the plurality of sub-engines include a sub-engine that executes an advertisement application for playing a motion image commercial related to a program content, and a sub-engine that executes an advertisement application having a function of operating a shopping site where merchandises are available for purchase. Hereinafter, the former sub-engine is referred to as a “related advertisement engine”, and the latter sub-engine is referred to as a “shopping engine”.

When the operation unit accepts an operation performed to select a type of an advertisement application, the application execution engine switching unit 215 controls the application execution engine 213′ such that only a sub-engine corresponding to the selected type operates. Note that the operation unit may be an input device such as a keyboard, a mouse, a remote control, or the like. Alternatively, in a case where the display unit 220 is a touch-panel type display, the operation unit may be a touch panel.

The application execution engine switching unit 215 may store, in the storage unit 214, selection information indicating a type of an advertisement application selected immediately previously. In this case, when the television receiver 10′ is started, the application execution engine switching unit 215 may read the selection information from the storage unit 214 and may control the application execution engine 213′ according to the read selection information.

### (Communication Server 400′)

In the communication server 400′, there are stored a large number of advertisement applications having a function of operating a shopping site where it is allowed to purchase merchandises.

Furthermore, in the communication server 400′, keywords related to the respective advertisement applications are registered. For example, for an advertisement application of a shopping site where it is allowed to purchase a merchandise of “OO cold medicine”, whose commercial is now being broadcast, a keyword “OO cold medicine” is registered in relation to this advertisement application.

### (Application Management Server 600)

The application management server 600 is a server that manages a site where it is allowed to acquire an advertisement application to play a moving image commercial. Based on a related-advertisement application management table 5 stored in a storage unit (not illustrated), the application management server 600 transmits information necessary for the sub-device 200 to acquire the advertisement application.

### (Control Information)

In the present embodiment, the control information transmitted from the broadcasting device 300 includes a content ID. The content ID may preferably include two types of content IDs, that is, a program content ID and a commercial content ID. In this case, a value of one type of content ID is different from a value of the other one type of content ID. Preferably, the content ID may have different values for respective scenes of a program content, and different values may be preferably assigned for respective commercial contents accompanying the program content.

Regarding scenes of a program content, the broadcasting device 300 may preferably transmit control information including a content ID corresponding to each of the scenes, immediately before or after a broadcast time of the scene. Similarly, regarding commercial contents, the broadcasting device 300 may preferably transmit control information including a content ID corresponding to each of the commercial contents immediately before or after a broadcast time of the commercial content. In the control information described above, it is desirable that an execution start time of a related advertisement application indicated by start time information is equal to an acquisition time of the related advertisement application indicated by acquisition time information.

The value of each content ID may be determined individually by each broadcasting organization and may be assigned to a commercial content, or an advertisement spot provider other than the broadcasting organizations may determine a content ID assigned to each commercial content. In this case, the broadcasting device 300 of each broadcast station transmits control information including a content ID given according to a determination by an advertisement spot provider. This makes it possible to avoid complexity in management that occurs when each broadcasting organization manages content IDs.

### (Operation Television Receiver 10′)

A operation of the television receiver 10′ is described below with reference to FIG. 9 for a case where the broadcasting device 300 corresponding to a current channel of the television receiver 10′ transmits an advertisement application.

Note that the television receiver 10′ operates in a similar manner to the television receiver 10 except that a process described below is performed instead of performing the process in S18 to S21 shown in FIG. 3.

That is, after step S16 or S17, the application execution engine 213′ transmits identification information of a sub-engine being in operation (that is, information indicating a type of an advertisement application selected by a user) and a content ID included in control information to the application management server 600.

When an application management unit 610 of the application management server 600 receives the identification information and the content ID, the application management unit 610 refers to the related-advertisement application management table 5 and transmits, to the sub-device 200, information necessary for the sub-device 200 to acquire the advertisement application. For example, in a case where the content ID is “00001” and the identification information indicates “related advertisement engine”, the application management unit 610 transmits “http://xxx-seiyaku.co.jp/index.html” as an acquisition site URL of the advertisement application to the sub-device 200. Herein, a source of index.html includes an object tag described such that an attribute value of a codebase attribute indicates a file name of the advertisement application. In another example in which the content ID is “00001” and the identification information indicates “shopping engine”, the application management unit 610 transmits a character string indicating a trade name “OO cold medicine” to the sub-device 200. Thereafter, using the received information, the sub-device 200 acquires the advertisement application.

More specifically, in a case where the related advertisement engine is in operation, the application execution engine 213′ acquires the advertisement application by accessing the acquisition site URL. For example, if the application execution engine 213′ accesses a URL “http://xxx-seiyaku.co.jp/index.html”, then a server with a host name “xxx-seiyaku.co.jp” transmits an advertisement application with a file name indicated by an attribute value of a codebase attribute to the sub-device 200. The application execution engine 213′ receives this advertisement application.

On the other hand, in a case where the shopping engine is in operation, the application execution engine 213′ supplies a character string indicating a trade name to the control information processing unit 212, and the control information processing unit 212 transmits this character string to the communication server 400′. An application distribution unit 410′ of the communication server 400′ transmits an advertisement application stored in relation to the received character string (keyword) to the sub-device 200. For example, in a case where the trade name is “OO cold medicine”, the application distribution unit 410′ transmits an advertisement application stored in relation to a keyword of “OO cold medicine”, associated with a shopping site where “OO cold medicine” is available for purchase, to the sub-device 200.

After the process described above is completed, by performing a process in S22 and following processes, it becomes possible for the sub-device 200 to present the shopping site where “OO cold medicine” is available for purchase timely to a viewer who is viewing a commercial content associated with the “OO cold medicine”.

It is not necessary to change control information even in a case where a new type of sub-engine is added, and thus, if information corresponding to this sub-engine is registered in the application management server 600 before the new sub-engine is added, it becomes possible for the television receiver 10′ to display an advertisement of a type corresponding to this sub-engine. Furthermore, it becomes possible to reduce the amount of metadata transmitted on a broadcast wave.

The television receiver 10′ according to the present embodiment has been described above. As can be seen from the above description, the television receiver 10′ according to the present embodiment provides an advantage that, by executing an advertisement application of a type selected by a viewer, it is possible to display a related-advertisement in a manner according to a preference of the viewer.

### (Operation of Switching Channel in the Television Receiver 10 According to one of First to Third Embodiments)

Hereinafter, an operation of switching a channel in the television receiver 10 according to one of the first to third embodiments is described with reference to FIG. 6. FIG. 6 is a diagram schematically illustrating a manner in which an advertisement is displayed on the television receiver 10 before and after a channel is switched.

Hereinafter, a channel before being switched is referred to as “channel A”, while a channel selected via the switching is referred to as “channel B”. Furthermore, an advertisement application of a main advertisement being in operation until the channel is switched is referred to as an “application A”, while an advertisement application of a related-advertisement being in operation until the channel is switched is referred to as an “application A′”. Similarly, an advertisement application of a main advertisement executed after the channel is switched is referred to as an “application B”, while an advertisement application of a related-advertisement executed after the channel is switched is referred to as an “application B”.

Control information transmitted together with the application B by the broadcasting device 300 of the channel B includes management information associated with an old advertisement application. This management information indicates that the operation of the old advertisement application (application A′) being in operation before the application B′ is started is to be continued after the application B′ is started. Furthermore, this management information also indicates that after the new advertisement application is started, a related-advertisement dealt with by the new advertisement application is to be displayed in a left-hand area of a screen, and a related-advertisement dealt with by the old advertisement application is to be displayed in a right-hand area of the screen.

After the channel is switched, when a transmission time of the application B is reached, the television receiver 10 receives the application B, that is, the advertisement application of the main advertisement and the control information indicating the method of controlling displaying the related-advertisement. If the television receiver 10 receives the application B, then the television receiver 10 immediately starts the application B and displays the main advertisement.

At the same time, based on the control information, the television receiver 10 receives the application B′ from the communication server 400. Upon receiving the application B′, as illustrated in FIG. 6, the television receiver 100 reduces the display area of the related-advertisement being displayed, by the execution of the application A′, over the whole screen area of the display unit 220 to a right-hand half area of the screen, and furthermore the television receiver 100 starts the application B′ and displays a related-advertisement in a left-hand half area of the screen.

Thereafter, when it becomes a time indicated by the end time information included in the control information received by the television receiver 10 together with the application A, then as illustrated in FIG. 6, the television receiver 10 ends the application A′ and deletes the related-advertisement displayed in the right-hand area of the screen of the display unit 220. The television receiver 10 then expands the area, in which the related-advertisement is displayed by executing the application B′, from the left-hand half area of the screen of the display unit 220 to the whole screen area of the display unit 220.

In the television receiver 10, as can be seen from the above description, for a while after the channel is switched to the channel B, the television receiver 10 continues displaying the related-advertisement of the sponsor of the program on the channel A played by the television receiver 10 before the channel is switched.

Therefore, a user who is interested in both the program on the channel B and the advertisement of the sponsor of the program on the channel A is allowed to acquire information provided by the advertisement for a while after the channel is switched to the channel B.

### (Note 1)

Regarding a sub-device given permission by a broadcasting organization to display a related-advertisement, this sub-device may be registered in the authentication server 500. To register the sub-device in the authentication server 500, the broadcasting organization may input an ID of this sub-device (a sub-device ID) in the authentication server 500. In a case where the broadcasting organization permits only sub-devices with IDs that end with a “even” number to display a related-advertisement, the broadcasting organization may input information indicating the above condition thereby registering sub-devices with IDs that end with a “even” number in the authentication server 500.

Regarding related-advertisements given permission by a broadcasting organization or another advertisement spot provider to be displayed on the sub-device, IDs of advertisement applications for displaying the related-advertisements may be registered in the authentication server 500. In the authentication server 500, display area specifying information may be registered in relation to the ID of each advertisement application to limit a display location where a related-advertisement is displayed by the sub-device by executing the advertisement application. Note that registration of an ID of an advertisement application (and also the display area specifying information if necessary) in the authentication server 500 may be performed by an advertisement spot provider who accepts an advertisement spot usage request issued by an advertisement requester.

In the sub-device 200, a predetermined sub-device ID may be stored in the storage unit 214.

The control information may include information indicating a ID of an advertisement application (application ID information) for displaying a related-advertisement and also information indicating whether or not authentication by the authentication server 500 is necessary.

In a case where the control information received by the sub-device 200 indicates that the authentication by the authentication server 500 is necessary, the sub-device 200 may transmit the application ID information and the sub-device ID to the authentication server 500. In a case where the ID of the advertisement application for displaying the related-advertisement and the sub-device are both registered in the authentication server 500, the authentication server 500 may transmit information indicating that the related-advertisement is permitted to be displayed to the sub-device 200, but otherwise the authentication server 500 may transmit information indicating that the related-advertisement is not permitted to be displayed to the sub-device 200. In a case where the display area specifying information is stored in the authentication server 500 in relation of the ID of the advertisement application for displaying the related-advertisement, the authentication server 500 may transmit the display area specifying information together with the information indicating that the related-advertisement is permitted to be displayed to the sub-device 200. Whenever this is the case, the sub-device 200 displays a related-advertisement dealt with by a corresponding advertisement application such that the related-advertisement is displayed inside a part of the area (an area specified by the display area specifying information) of the display area of the display unit 220.

### (Note 2)

When the power of the television receiver 10 is turned on, the main device 100 and the sub-device 200 perform following operations.

That is, the main device 100 starts playing a program on a current channel. Thereafter, when an advertisement application of a main advertisement is transmitted from the broadcasting device 300, the main device 100 starts the advertisement application to display the main advertisement.

On the other hand, regarding the operation by the sub-device 200, in a case where control information and an advertisement application based on this control information are stored in the storage unit 214, the sub-device 200 determines, based on the control information, whether or not the advertisement application is to be immediately started. In a case where it is needed to immediately start the advertisement application, the sub-device 200 immediately starts the advertisement application and displays the related-advertisement.

On the other hand, in a case where although there is control information stored in the storage unit 214, an advertisement application has not been acquired based on this control information, the sub-device 200 determines based on the control information whether the advertisement application is to be immediately acquired and immediately started. In a case where it is needed to immediately acquire the advertisement application, the sub-device 200 immediately acquires the advertisement application from the communication server 400. Furthermore, in a case where it is needed to immediately start the advertisement application, the sub-device 200 immediately starts the advertisement application and displays the related-advertisement.

### (Note 3)

The old-application state management information included in the control information may include information indicating whether the display area for an old advertisement application is to be set to be equal in size to the display area for a new advertisement application or the display area for the old advertisement application is to be set to be smaller in size than the display area for the new advertisement application.

The above-described old-application state information may include information indicating where in the screen of the display unit 220 the display area for the old advertisement application is to be set. For example, the above-described old-application state information may include information indicating that the display area for the old advertisement application is to be set in a corner of the screen of the display unit 220.

The above-described old-application state information may include information indicating whether the old advertisement application is to be operated in background or foreground.

The above-described old-application state information may include information indicating that a new advertisement application is not to be started as long as an old application is still in operation even when it becomes an execution start time at which the new advertisement application is specified, by start time information, to be started.

Regarding information included in the control information, the acquisition time information, the start time information, and the end time information do not necessarily need to be information explicitly indicating a time at which an advertisement application is to be acquired, a time at which the advertisement application is to be started, and a time at which the advertisement application is to be ended. For example, the end time information may be information implicitly indicating a time at which the advertisement application is to be ended, such as a time “30 seconds after the execution start time”, a time “15 seconds after the channel is switched”, a time “5 minutes after the program end time”, or the like.

### (Note 4)

In each embodiment described above, the main device 100 transmits original control information prepared by a distributor directly to the sub-device 200. However, the present invention is not limited to this mode.

That is, the broadcasting device 300 may not transmit control information, and the main device 100 may generate control information by itself based on a content of a program transmitted by the broadcasting device 300 and may transmit the generated control information to the sub-device 200. In this case, the main device 100 may generate the control information only when a command is received from the broadcasting device 300.

For example, the application execution engine 131 may be configured such that when the content processing unit 120 receives an image frame including a QR code (registered trademark) indicating a URL from the broadcast reception unit 110, the application execution engine 131 is capable of detecting this fact. The application execution engine 131 may perform the above-described detection on image frames in a commercial image only during a period in which the commercial image is played. When the application execution engine 131 detects that the content processing unit 120 has received an image frame including a QR code indicating a URL, then the application execution engine 131 may generate control information such that the control information includes the URL information indicating the URL described above and such that the acquisition time information and the start time information indicate the time of the detection.

Furthermore, for example, the application execution engine 131 may be configured such that when the content processing unit 120 receives, from the broadcast reception unit 110, an image frame in which a character string of a URL is embedded, the application execution engine 131 is capable of recognizing the character string in the image. In this case, the application execution engine 131 may perform the recognition of the character string in image frames in a commercial image only during a period in which the commercial image is played. When the application execution engine 131 recognizes a character string in an image frame, if the application execution engine 131 determines that this character string is a character string of a URL, then the application execution engine 131 may generate control information such that the control information includes the URL information indicating the URL described above and such that the acquisition time information and the start time information indicate the time of the detection.

In any example, the application execution engine 131 may transmit the generated control information to the sub-device 200. The sub-device 200 may immediately acquire data from an acquisition site indicated by the URL based on the received control information.

By configuring the sub-device 200 in the above-described manner, when the URL described above indicates where an advertisement application of a related-advertisement is available for download, the sub-device 200 may automatically download the advertisement application and start it to display the related-advertisement. That is, the television receiver 10 is capable of presenting a related-advertisement to a viewer without the viewer having to manually input a URL presented in a program image or a commercial image.

### (Note 5)

In each embodiment described above, as an example of the present invention, a description has been given as to the television receiver 10 including the main device 100 functioning as the broadcast reception device and the sub-device 200 functioning as the communication device both disposed in a housing. However, the present invention is not limited to such a configuration, but the television receiver 10 may be realized as a television receiver and a tablet terminal each of which is allowed to be placed at a desired place.

Note that the television receiver 100′ shown in FIG. 7 includes the same parts as those of the main device 100, and the tablet terminal 200′ in FIG. 7 includes the same parts of the sub-device.

### (Note 6)

The control information transmitted by the broadcasting device 300 may include all or part of synchronization time information, version information, and an application ID information. The main device 100 may generate, as the control information, one or both of channel switching information and main advertisement switching information.

The synchronization time information is information to be referred to by the television receiver 10 to achieve synchronization between a main advertisement application and a related advertisement application in playing.

The channel switching information is information that is generated by the main device 100 and supplied to the sub-device 200 when the channel is switched in the television receiver 10. In response to acquiring this information, the sub-device 200 may acquire a related advertisement application from an acquisition site indicated by URL information acquired most recently.

The main advertisement switching information is information generated by the main device 100 when the main device 100 switches the main advertisement being displayed. In response to acquiring this information, the sub-device 200 may acquire a related advertisement application from an acquisition site indicated by URL information acquired most recently.

The version information is information indicating a latest version of each advertisement application stored in the communication server 400. In a case where when the sub-device 200 refers to the version information, if it turns out that there is an advertisement application of an old version in the storage unit 214, the sub-device 200 may acquire the advertisement application of the latest version from the communication server 400.

### (Note 7)

Regarding the URL information, the control information may include a plurality of pieces of URL information depending on sizes of the display screen where a related-advertisement is displayed. More specifically, the control information may include URL information of each of three advertisement applications produced for use in being displayed on small, middle, and large screens.

In a case where a URL is described in control information such that the URL is located to the right of a character string “[lessthan5inch]”, then the television receiver 10 may regard this URL as a URL of an advertisement application produced for use in being displayed on a small screen (a screen smaller than 5 inches). Similarly, in a case where a URL is described in control information such that the URL is located to the right of a character string “[lessthan10inch]”, then the television receiver 10 may regard this URL as a URL of an advertisement application produced for use in being displayed on a middle screen (a screen equal to or greater than 5 inches and smaller than 10 inches).

Similarly, in a case where a URL is described in control information such that the URL is located to the right of a character string “[over10inch]”, then the television receiver 10 may regard this URL as a URL of an advertisement application produced for use in being displayed on a large screen (a screen equal to or greater than 10 inches).

In this case, the television receiver 10 may refer to the control information and acquire an advertisement application adapted to the size of the display unit 220 from the communication server 400.

As described above, the control information may include displaying form information, such as “[lessthan5inch]”, “[lessthan10inch], “[over10inch]”, or the like, for allowing the television receiver 10 to acquire an advertisement application adapted to the size of the display screen.

### [Embodiments Using Software]

Finally, each block of the television receiver 10 or 100′, in particular, the content processing unit 120, the application execution engine 131, and the control information management unit 132 may be realized by hardware using a logic circuit formed on an integrated circuit (IC chip), or may be realized by software using a CPU (Central Processing Unit).

In the latter case, the television receiver 10 or 100′ includes a CPU that executes commands of a program for realizing each function, a ROM (Read Only Memory) in which the program described above is stored, a RAM (Random Access Memory) in which the program described above is loaded, and a storage device (storage medium) such as a memory or the like in which the program described above and various kinds of data are stored. The object of the present invention may also be achieved such that program codes (executable-form program, intermediate-code program, source program) of a control program for controlling the television receiver 10 or 100′ so as to realize the functions described above are stored in a computer-readable form in a storage medium, the storage medium is supplied to the television receiver 10 or 100′, and a computer (or a CPU, an MPU, or the like) in the television receiver 10 or 100′ reads out the program codes stored in the storage medium and executes them.

As for the storage medium described above, a non-transitory tangible medium may be used. For example, tapes such as a magnetic tape, a cassette tape, and the like, magnetic disks such as a floppy (registered trademark) disk/hard disk, optical disks such as a CD-ROM/MO/MD/DVD/CD-R and the like, cards such as a IC card (or a memory card)/optical card, semiconductor memories such as a mask ROM/EPROM/EEPROM (registered trademark)/flash ROM and the like, and logic circuits such as a PLD (Programmable logic device), FPGA (Field Programmable Gate Array), and the like may be used.

Alternatively, the television receiver 10 or 100′ may be configured so as to be connectable to a communication network, and the program codes described above may be supplied via the communication network. There is no specific restriction on the communication network as long as it is possible to transmit the program codes. For example, the Internet, an intranet, an extranet, a LAN, a ISDN, a VAN, a CATV communication network, a virtual private network, a telephone network, a mobile communication network, a satellite communication network, or the like may be used. Furthermore, there is no specific restriction on a structure or a type of a transmission medium used in the communication network as long as the medium is capable of transmitting the program codes. For example, a wired communication medium such as IEEE1394, USB, power-line carrier, a cable TV line, a telephone line, ADSL (Asymmetric Digital Subscriber Line), or the like, or a wireless communication medium such as an infrared ray such as IrDA, a remote control, Bluetooth (registered trademark), IEEE802.11 wireless communication line, an HDR (High Data Rate), NFC (Near Field Communication), DLNA (Digital Living Network Alliance), a portable telephone network, a satellite line, a digital terrestrial network, or the like may be used. Note that the present invention may also be realized in the form of a computer data signal in which the program codes described above are embodied by being electronically transmitted and which is embedded on a carrier.

The present invention is not limited to the embodiments described above, but various modifications are possible within the scope described in claims. Embodiments may also be possible by properly combining technical means disclosed in different embodiments, and the resultant embodiments fall within the technical scope of the present invention. Furthermore, by combining technical means disclosed in embodiments, it is possible to create a new technical feature.

### [Summary]

In a first aspect of the present invention, a program playing device (main device 100, television receiver 100′) includes reception means (broadcast reception unit 110) that receives a program accompanied by an advertisement from a program distribution device (broadcasting device 300), play means (content processing unit 120) that plays so as to display a program image on a display unit (display unit 140), display means (application execution engine 131) that displays the advertisement on the display unit, and transmission means (application execution engine 131) that transmits, to an external display device (sub-device 200, tablet terminal 200′) configured to receive a related-advertisement related to the advertisement from an advertisement distribution device (communication server 400) and display the received related-advertisement, control information indicating a method of controlling displaying the related-advertisement on the display device, wherein the display device is a device that controls displaying the related-advertisement according to the method of controlling displaying the related-advertisement indicated by the control information. Note that the program distribution device and the advertisement distribution device may be realized integrally in a single device or may be realized separately.

The program playing device configured in the above-described manner transmits control information indicating a method of controlling displaying the related-advertisement on the display device to the display device that receives the related-advertisement related to the main advertisement from the advertisement distribution device and displays it.

The display device located outside the program playing device controls the displaying of the related-advertisement according to the displaying control method indicated by the control information.

Thus, the program playing device provides an advantage that it is possible to display an advertisement in a flexible manner on the display device.

Preferably, in the program playing device in a second aspect of the present invention based on the first aspect, the play means is configured such that when the program playing device accepts a channel switching operation, the play means ends playing of a program on an old channel being played before the channel is switched and plays a program on a channel selected via the switching, and the transmission means transmits, to the display device, control information indicating that when displaying is still continued for a related-advertisement related to an advertisement associated with the program on the old channel played before the switching is performed, the displaying of the related-advertisement is to be continued after the channel is switched.

In the program playing device configured in the above-described manner, even after a viewer switches the channel from the channel A to the channel B, the displaying is continued for the related-advertisement related to the advertisement associated with the program on the channel A being played by the television receiver 10 before the channel is switched.

Thus, the program playing device provides a further advantage that a user who is interested in both the program on the channel B and the advertisement of the sponsor of the program on the channel A is allowed to acquire information provided by the advertisement even after the channel is switched to the channel B.

Preferably, in the program playing device in a third aspect of the present invention based on the first or second aspect, the program distribution device is configured to transmit the control information together with a program accompanied by the advertisement, the transmission means is configured to, in response to receiving the control information from the program distribution device, transmit the control information to the display device, and the control information indicates that the related-advertisement is to be acquired from an acquisition site indicated by a URL included in the control information.

Preferably, in the program playing device in a fourth aspect of the present invention based on the first or second aspect, the main device 100 displays a commercial image as the advertisement described above, and the program playing device further includes determination means (application execution engine 131) that determines whether or not a URL is included in an image frame of the commercial image, and a production unit (application execution engine 131) that generates control information such that if the determination means determines that the URL is included in the image frame, the production unit generates control information so as to include the URL, wherein the transmission means is configured such that when the production unit generates the control information, the transmission means transmits the control information, and the production unit generates the control information indicating that the related-advertisement is to be acquired from an acquisition site indicated by a URL included in the control information.

In the program playing device configured in the above-described manner, if a URL indicating an acquisition site of a related-advertisement is included in the commercial image, it is possible to present the related-advertisement to a viewer without the viewer having to manually input the URL presented in the commercial image.

Preferably, in the program playing device according to a fifth aspect of the invention based on one of the first to fourth aspects, the transmission means transmits the control information including position information (coordinate specifying information) indicating a location where the related-advertisement is to be displayed by the display device.

Preferably, in the program playing device according to the sixth aspect of the invention based on one of the first to fifth aspects, the transmission means is configured to transmit control information including a plurality of URLs corresponding to attributes of users, each URL indicating an acquisition site of the related-advertisement, and the display device is configured to select a URL corresponding to an attribute registered in the display apparatus from the plurality of URLs and acquire the related-advertisement from an acquisition site indicated by the selected URL.

The program playing device configured in the above-described manner further provides an advantage that if attributes of main users of the display device are registered in the display apparatus, then the program playing device is capable of presenting a related-advertisement in a manner adapted to the attributes of the users.

In a seventh aspect of the present invention, a program playing device may be configured such that the program playing device according to one of the first to sixth aspects and the display device are disposed in a housing.

In a ninth aspect of the present invention, an advertisement display control method includes receiving a program accompanied by an advertisement from a program distribution device, playing the program so as to display a program image on a display unit, displaying the advertisement on the display unit, and transmitting, to an external display device that receives a related-advertisement related to the advertisement and displays the related-advertisement, control information indicating a method of controlling displaying the related-advertisement on the display apparatus, wherein the display device is an apparatus that controls displaying of the related-advertisement according to the method of controlling displaying the related-advertisement indicated by the control information.

In the advertisement display control method described above, the steps described above provide an operational advantage similar to that achieved by the program playing device in the first aspect of the present invention.

The above-described program playing devices (the program playing devices according to respective first to seventh aspects) may each be realized using a computer. In this case, a program that controls the computer so as to operate as each means of the program playing device thereby realizing the program playing device using the computer, and a computer-readable storage medium in which the program is stored both fall within the scope of the present invention.

### INDUSTRIAL APPLICABILITY

The present invention may be applied to various kinds of terminals capable of playing a program accompanied by an advertisement.

### REFERENCE SIGNS LIST

10 television receiver
100 main device (program playing device)
100′ television receiver (program playing device)
110 broadcast reception unit (reception means)
120 content processing unit (play means)
130 main advertisement processing unit
131 application execution engine (display means, transmission means, production unit, determination means)
132 control information management unit
133 storage unit
140 display unit
200 sub-device (external display device)
200′ tablet terminal (external display device)
210 related advertisement processing unit
211 control information acquisition unit
212 control information processing unit
213 application execution engine
214 storage unit
220 display unit
300 broadcasting device (program distribution device)
400 communication server (advertisement distribution device)
500 authentication server

1. A program playing device comprising:
a reception unit that receives a program accompanied by an advertisement from a program distribution device;
a display unit that displays the advertisement;
a play unit that plays the program so as to display a program image on the display unit;
a transmission unit that transmits, to an external display device configured to receive a related-advertisement related to the advertisement from an advertisement distribution device and display the received related-advertisement, control information indicating a method of controlling displaying the related-advertisement on the display device,
wherein the display device is an apparatus that controls displaying the related-advertisement according to the method of controlling displaying the related-advertisement indicated by the control information.

2. The program playing device according to claim 1, wherein
the play unit is configured such that in a case where the program playing device accepts a channel switching operation, the play unit ends playing of a program on an old channel being played before the channel is switched and plays a program on a channel selected via the switching, and
the transmission unit transmits, to the display device, control information indicating that in a case where displaying is still continued for a related-advertisement related to an advertisement associated with the program on the old channel played before the switching is performed, the displaying of the related-advertisement is to be continued after the channel is switched.

3. The program playing device according to claim 1, wherein
the program distribution device is configured to transmit the control information together with a program accompanied by the advertisement,
the transmission unit is configured to, in response to receiving the control information from the program distribution device, transmit the control information to the display device, and
the control information indicates that the related-advertisement is to be acquired from an acquisition site indicated by a URL included in the control information.

4. The program playing device according to claim 1, wherein
the transmission unit is configured to transmit control information including a plurality of URLs corresponding to attributes of users, each URL indicating an acquisition site of the related-advertisement, and
the display device is configured to select a URL corresponding to an attribute registered in the display apparatus from the plurality of URLs and acquire the related-advertisement from an acquisition site indicated by the selected URL.

5. A computer program that controls a computer so as to operate as the program playing device according to claim 1, wherein the program causes the computer to function as each unit of the program playing device.
